(19) United States
(12) Patent Application Publication
(10) Pub. No.: US 2023/0242176 A1
(43) Pub. Date: Aug. 3, 2023

(54) Modular Electric Power Steering System

(71) Applicant: Robert Bosch GmbH, Stuttgart (DE)

(72) Inventors: Stephanus Sebastiaan Bester, Jena (DE); Florian Mueller, Schorndorf (DE)

(21) Appl. No.: 18/003,419

(22) PCT Filed: Apr. 6, 2021
(86) PCT No.: PCT/EP2021/058926

§ 371 Date: Dec. 27, 2022

(30) Foreign Application Priority Data
Jul. 2, 2020 (DE) 10 2020 208 275.8

(51) Int. Cl. B62D 5/04; B62D 3/12; F16H 57/025; F16H 57/039

(52) U.S. Cl. CPC B62D 5/0448; B62D 5/0424; B62D 3/12; F16H 57/025; F16H 57/039

(57) ABSTRACT

A modular electric power steering system is disclosed. The system includes a tubular neck which guides a universal joint. The tubular neck has a certain bend angle. The system further includes a drive assembly that has an electric motor which is controlled by a control unit. The system additionally includes a gearbox assembly having a torque sensor and a gearbox. The system also includes a steering rod that has a shortenable tube. Further, the system includes a gearbox housing that houses the gearbox assembly. In addition, the system includes two tubular toothed rack housing halves that are shortenable. The gearbox housing is disposed between the two toothed rack housing halves. The system also includes two feet which are disposed at the respective outer end of the two toothed rack housing halves. The feet serve to fasten the power steering system to the vehicle. And the feet include a bushing for guiding the toothed rack.

The present invention relates to a modular electric power steering system for a motor vehicle. The invention also relates to a method for producing a modular electric power steering system.

### PRIOR ART

The electric servo steering system generates steering assistance with the help of an electric motor, the power of which is transmitted to the toothed rack via a servo gearbox. The steering command is registered by a torque sensor system, which measures the deflection of the torsion bar connected to the steering and transmits this data to the control unit.

In an EPSp, the servo unit is located on the steering pinion. The assistance torque of the electric motor is transmitted with the help of a worm gear mechanism.

In an EPSapa, the electric motor is seated axially parallel to the toothed rack and the steering assistance is transmitted directly to the toothed rack by means of a ball screw drive with a belt drive.

The individual components of an electrical servo steering system are disposed in a steering housing. Developing and providing a steering housing to meet customer requirements is very complex and expensive. For low volume series, the expensive development of a steering housing is not worthwhile. It also takes several years for a new steering housing to be developed and available on the market. The market, however, demands that the production of an electric servo steering system be flexible.

The object of the invention is therefore to provide a servo steering system that can be developed inexpensively and in as short a time as possible. The intention is to also be able to serve small customers and low volume series.

This object is achieved by the subject matter of claim 1 and by the method according to claim 4. Advantageous embodiments are the subject matter of the further claims and emerge from the following description of the invention.

The idea of the invention is to divide a servo steering system into individual modules and to use as many carry-over parts as possible. The carry-over parts can be oversized (e.g. designed for maximum rack force), but then already have the corresponding component approvals. This can significantly reduce the development time.

Flexibility is achieved by making it possible to individually shorten and adjust the various elements. The toothed rack and the two housing halves in which the toothed rack is disposed can thus easily be shortened to the required length.

The two toothed rack housing halves are made of high-strength standard tubes. The toothed rack is likewise made of a high-strength standard tube. After shortening the toothed rack, the toothing element is welded onto the tube for an EPSp. Alternatively, in an EPSapa, a tubular component with the ball screw is placed on the toothed rack and fastened. The threads for the tie rods are cut as well.

In addition, in the case of a tubular neck which guides the constant velocity joint for connection to the intermediate shaft or steering spindle, the bend angle can be adjusted. The tubular neck ensures that the two joints of the universal joint are disposed at a proper angle to one another so that the cardan error is reduced.

The gearbox housing is disposed between the two toothed rack housing halves. The steering gearbox and the servo unit are accommodated in the gearbox housing. An electric motor with a control unit is connected to the steering gearbox in the usual manner. All of the aforementioned elements are carry-over parts and can be selected from a standardized kit.

So-called feet are disposed on the outer ends of the two toothed rack housing halves. The feet consist of a tubular portion, which includes a bushing for guiding the toothed rack. On the outside, the feet have projections comprising a bore, with which the steering system can be screwed into the vehicle. During assembly, the feet are first rotated to the required installation angle of the steering system. Correct setting of the installation angle is critical to reducing the cardan error at the universal joint. The feet are then fastened to the respective toothed rack housing half. This can be accomplished by pressing, shrinking or welding.

A design example is described with reference to the figures. The figures show:

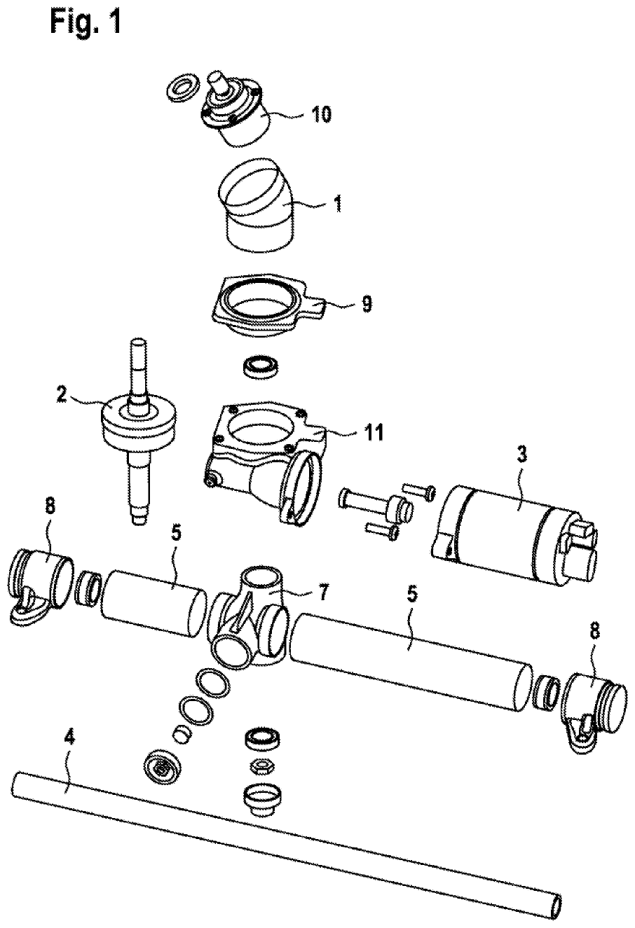

FIG. 1 an exploded view of the modular steering system according to the invention

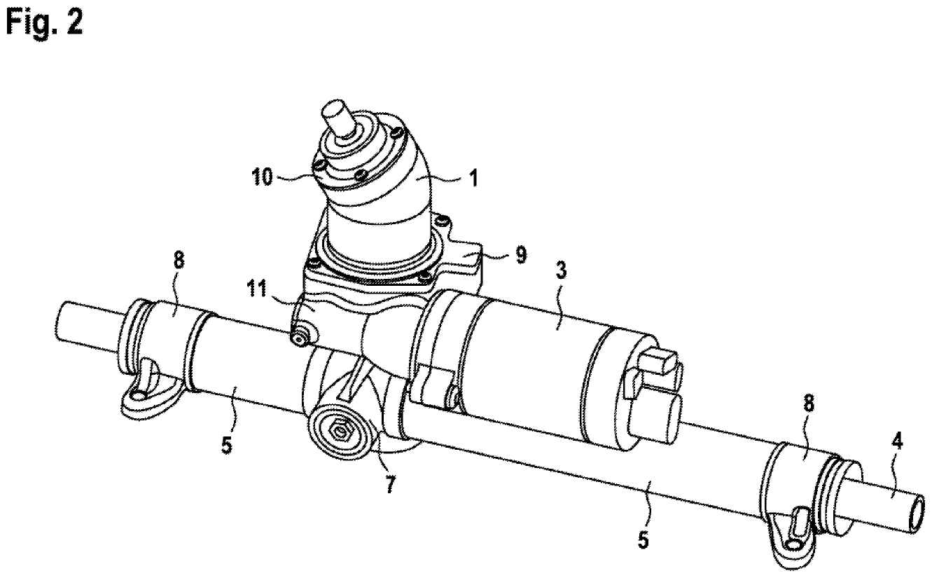

FIG. 2 a perspective view of the modular steering system according to the invention

The design example is explained with reference to an EPSp in which the servo unit is located on the steering pinion.

FIG. 1 shows an exploded view of the modular steering system according to the invention. The toothed rack 4 consists of a high-strength standard tube to which a toothing element is fastened. The gearbox housing here consists of a lower gearbox housing 7 and an upper gearbox housing 11. The pinion, which is in engagement with the toothed rack 4, is accommodated in the lower gearbox housing 7. In addition, a pressure piece for pressing the toothed rack against the pinion is provided in the lower gearbox housing 7 in the usual manner. The upper gearbox housing 11 houses the helical gear mechanism. A drive assembly 3, consisting of an electric motor and a control unit, is screwed to the upper gearbox housing 11. The upper gearbox housing 11 is furthermore closed with a cover 9.

The gearbox assembly 2 extends through the upper and the lower gearbox housing 7, 11 and consists of a torque sensor, a helical gear and the pinion.

The feet 8 consist of a tubular portion and have projections, each comprising a bore, which are used to fasten the steering system in the vehicle. They include a bushing for guiding the toothed rack 4 and are fastened to the outer ends of the toothed rack housing halves 5.

The tubular neck 1 includes the universal joint 10, which is configured as a constant velocity joint. The tubular neck 1 is already bent and is moreover rotated along its longitudinal axis during assembly such that the angle for connection to the intermediate shaft is precisely set.

FIG. 2 shows a perspective view of the modular steering system according to the invention in the assembled state. After shortening the elements to the required length (toothed rack 4, toothed rack housing halves 5), the elements are first arranged in relation to one another. The elements (feet 8, tubular neck 1) are rotated in such a way that the required crossing and installation angles are set. The components are then fixedly connected, e.g. by pressing or welding.

1. A modular electric power steering system, comprising:
a tubular neck configured to guide a universal joint, wherein the tubular neck is configured to define a certain bend angle;
a drive assembly including an electric motor which is configured to be controlled by a control unit;
a gearbox assembly including a torque sensor and a gearbox;
a steering rod including a shortenable tube;
a gearbox housing that houses the gearbox assembly;
two tubular toothed rack housing halves that are shortenable, wherein the gearbox housing is disposed between the two tubular toothed rack housing halves; and
two feet which are disposed at the respective outer end of the two tubular toothed rack housing halves, wherein the two feet are configured to fasten the power steering system to the vehicle, and wherein the two feet include a bushing for guiding the toothed rack.

2. The modular electric power steering system according to claim 1, wherein:
the gearbox of the gearbox assembly is a helical gear mechanism;
the steering rod includes a tube to which a toothing element is fastened; and
the gearbox housing includes an upper gearbox housing in which the helical gear mechanism is accommodated and a lower gearbox housing in which the pinion is in engagement with the toothed rack.

3. The modular electric power steering system according to claim 1, wherein:
the gearbox of the gearbox assembly includes a belt gear and a ball and nut gear; and
the steering rod is a ball screw spindle.

4. A method for assembling a modular electric power steering system according to claim 1, comprising:
selecting a gearbox assembly, a drive assembly, a gearbox housing and the feet from a standardized kit;
adjusting a toothed rack to a desired length;
adjusting a tubular neck to a desired angle;
adjusting two tubular toothed rack housing halves to a desired length;
arranging and aligning the individual modules with respect to one another, wherein the feet are rotated relative to the toothed rack housing halves such that a desired installation angle is set, and wherein the tubular neck is rotated along its longitudinal axis such that the desired bend angle of the universal joint is set; and
fixedly assembling the individual modules by pressing, shrinking, and/or welding.
